(19) United States
(12) Patent Application Publication
(10) Pub. No.: US 2013/0263565 A1
(43) Pub. Date: Oct. 10, 2013

(54) Combine Harvester

(71) Applicant: Luc Alexa Yde, Bassevelde (BE)

(72) Inventor: Luc Alexa Yde, Bassevelde (BE)

(21) Appl. No.: 13/520,683

(22) PCT Filed: Jan. 5, 2011
(86) PCT No.: PCT/EP11/50108

§ 371 Date: Apr. 15, 2013

(30) Foreign Application Priority Data
Jan. 5, 2010 (BE) 2010/0007

(51) Int. Cl. A01D 41/12

(52) U.S. Cl. CPC A01D 41/1243
USPC 56/122

(57) ABSTRACT

A combine harvester is described having a stalk discharge system 10 which incorporate a chopper 12, a spreader 14 and flow control guides for defining multiple operator configurable flow paths through the stalk discharge system, The flow paths include a first flow path in which the stalks pass sequentially through the chopper 12 and the spreader 14 to be chopped and evenly distributed over the ground traversed by the header, and a second flow path in which the stalks bypass the chopper 12 and the spreader 14 to be deposited as a swath on the ground. In the invention, the flow control guides are additionally configurable to define a third flow path in which the stalks enter the spreader 14 without first passing through the chopper 12, to be evenly distributed un-chopped over the ground traversed by the header.

### TECHNICAL FIELD

The present invention relates to a combine harvester having a header for gathering crop from a field, threshing and separation mechanisms for separating the crop into grain, stalks and chaff, and a stalk discharge system.

### BACKGROUND ART

A combine harvester is an agricultural machine that automates the harvesting of crops, such as cereals and grass. As the construction of combine harvesters is well known and documented, it will only be described herein to the extent necessary to permit an understanding of the present invention.

At its front end, a combine harvester has a header which cuts the crop and transports it into a threshing mechanism. The threshing mechanism makes use of a beating action to remove the grain from the stalks and crushes the husks to produce chaff before passing the crop on to a separation mechanism. So-called “straw walkers” in the separation mechanism pick up only the stalks, which may be straw or blades of grass, and transport them to the back of the harvester. The grain and the chaff drop onto oscillating sieves that separate the grain from the chaff. The grain falls through the sieves and is collected and stored in a grain tank.

The chaff is a waste product that drops off the rear end of the sieves and is allowed to fall on the ground to act as a nutrient. Harvesters may have a spreader arranged at the rear end of the sieves to distribute the chaff evenly on the ground.

The present invention is concerned primarily with the stalk discharge system, which processes the stalks in different ways depending on how they are to be utilised.

Combine harvesters that are currently manufactured by the present applicant have a stalk discharge system which incorporates a chopper, a spreader and flow control guides that define multiple operator configurable flow paths for the stalks. In a first flow path, the stalks pass sequentially through the chopper and the spreader. They are chopped by the chopper then passed on to the spreader which evenly distributes them over the ground traversed by the header. In a second flow path, the stalks bypass the chopper and the spreader and are deposited as a swath on the ground.

During the grass seed harvest, the combine harvester is set in swathing mode as the grass is later to be formed into bales. The threshed grass is not chopped but is deposited behind the combine harvester in swaths or windrows. However, in order that the grass may dry out for baling, it is necessary to spread the grass swaths evenly over the surface of the field and this is a carried out using a tractor equipped with suitable spreading implement. Consequently, more man hours and fuel need to be expended in preparing the grass before it can be baled. Such a harvester is known for example from EP2138024.

During maize harvest, also the maize cobs and associated leaves are chopped and spread behind the combine. This however uses a lot of power and fuel. Swathing these cobs and leaves is not an option as it would create uneven field conditions.

### DISCLOSURE OF INVENTION

Technical Problem

The present invention seeks to improve efficiency by enabling a combine harvester to deposit the grass in a form in which it will dry out more quickly and be ready sooner for baling, without the need to carry out further work on the grass once the combine harvester has completed its task. Alternatively the present invention also seeks a simple and efficient system to spread maize cobs and associated leaves without the necessity of chopping them.

Technical Solution

In accordance with the present invention, there is provided a combine harvester comprising:
a header for gathering crop from a field; and
threshing and separation mechanisms for separating the crop into grain, stalks and chaff; and
a stalk discharge system, whereby the stalk discharge system comprises a chopper, a spreader and flow control guides for defining multiple operator configurable flow paths through the stalk discharge system, wherein the flow paths comprise a first flow path in which the stalks pass sequentially through the chopper and the spreader to be chopped and evenly distributed over the ground just traversed by the header, and a second flow path in which the stalks bypass the chopper and the spreader to be deposited as a swath on the ground, CHARACTERISED IN THAT the flow control guides are additionally configurable to define a third flow path in which the stalks enter the spreader without first passing through the chopper, to be evenly distributed un-chopped over the ground just traversed by the header.

Patent DE3829937 discloses a combine harvester comprising two spreaders. A first spreader for the chaff that is separated from the grain and whereby the non-chopped stalks can be guided to one position to be passed through this spreader. There is however a large difference in the mass flow rate of the stalks and the chaff, and a spreader designed to distribute chaff over the area traversed by the header cannot effectively spread the stalks over the same area. Further this combine harvester comprises a second spreader downstream of the chapper for spreading the chopped stalks that is executed as conventional guiding plates. in the present invention, the spreader used to distribute unchopped stalks is the same spreader as is used to spread the chopped stalks and is therefore designed to cope with the mass flow rate of the stalks, furthermore the combine harvester according to the invention in this way only comprises a single spreader for spreading the non-chopped as well as the chopped stalks.

The spreader preferably comprises two rotors that are counter-rotatable and a shielding partially surrounding the rotors, there being a rear opening in the shielding for admitting into the spreader stalks chopped by the chopper when the stalks follow the first flow path, and in the third flow path the flow control guides comprise a rear cover for the rear opening in the shielding of the spreader to prevent back flow of the stalks from the spreader into the chopper.

Such a spreader with rotors is capable to spread the stalks over a bigger distance which is necessary with broad headers. Furthermore such a spreader is less sensitive to accumulation and clogging during the spreading of non-chopped stalks than a conventional spreader with guide plates.

Conveniently, in the second flow path the stalks pass over a chute prior to their deposition on the ground as a swath, and in that a panel is provided in the chute which is movable or removable to enable the stalks to flow into the spreader when the flow control guides are configured to define the third flow path.

It is possible that the shielding is spaced from the rotors to allow a part of the flow to drop to the ground while the remainder is flung the rotors and deflected by the shielding to achieve the desired even distribution and ground coverage.

Advantageously, the distance between the shielding and the bladed rotors is adjustable.

It is advantageous that in the third flow path, the flow control guides comprise a flow divider that cooperates with the chute to direct the flow of stalks into the volume of the spreader swept by the rotors and to deflect the flow away from the centreline of the spreader.

### BRIEF DESCRIPTION OF DRAWINGS

The invention will now be described further, by way of example, with reference to the accompanying drawings, in which

FIG. 1 is a view of a known stalk discharge system as seen from the rear of a combine harvester,

FIG. 2 is a schematic side view of the stalk discharge system shown in FIG. 1,

FIGS. 3 and 4 are views similar view to those of Figures :1 and 2, respectively, of a discharge system embodying the present invention,

FIG. 5 is a perspective view from the rear of the combine harvester of the stalk discharge system in FIGS. 3 and 4 with the chopper omitted, and

FIG. 6 is a perspective view of the spreader of FIG. 5 as seen from its end facing the chopper.

### MODE(S) FOR CARRYING OUT THE INVENTION

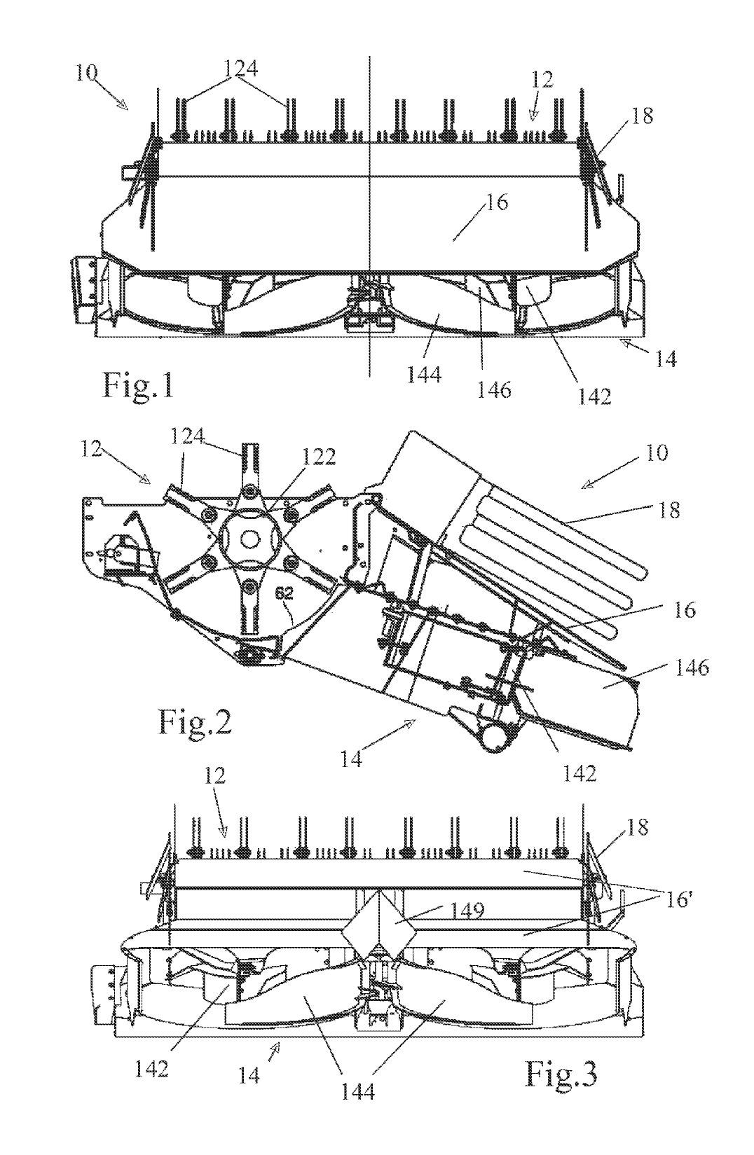

FIGS. 1 and 2 show a stalk discharge system that is already known and described in ER2138024, which is imported herein by reference. These two drawings are described herein only to enable the background to the invention to be understood and the interested reader is referred to the latter specification for a fuller explanation of details that are illustrated but not herein described,

The illustrated stalk discharge system 10 comprises a chopper 12 and a spreader 14. The chopper has a rotor 122 with blades 124 which chop the stalks into smaller pieces. Chopped stalks from the chopper 12 enter the spreader 14 through a rear opening in the casing of the spreader 14.

The spreader 14 comprises two counter rotating rotors 142 with parallel axes slightly inclined to the vertical, Shielding 144 surrounds the rotors 142 and is spaced from the tips of their blades 146, The blades 146 act to fling the stalks out radially and the shielding 144 guides the stalks to disperse them evenly over the ground. Because of the space between the blades 146 and the shielding 144, some of the stalks also fall directly onto the ground so that an even distribution can be achieved across the full width of the strip just traversed by the header of the combine harvester.

In the prior art, a flow control guide (not shown) is arranged above the chopper 12 which may simply be a deflector flap pivotably mounted above the mouth of the chopper. In one position of the flow control guide, the stalks are guided either to drop into the chopper 12 so that they are chopped and then spread in the manner described above. In a second position of the flow control guide, the mouth of the chopper is covered and the stalks are deflected to bypass the chopper 12 and the spreader 14 and to fall onto the ground as a swath for later collection and baling. In this second position, the stalks leaving the straw walkers are guided onto an inclined chute 16 which lies over the spreader 14 so that the stalks fall onto the ground as a swath of which the width is limited by two laterally disposed rakes 18.

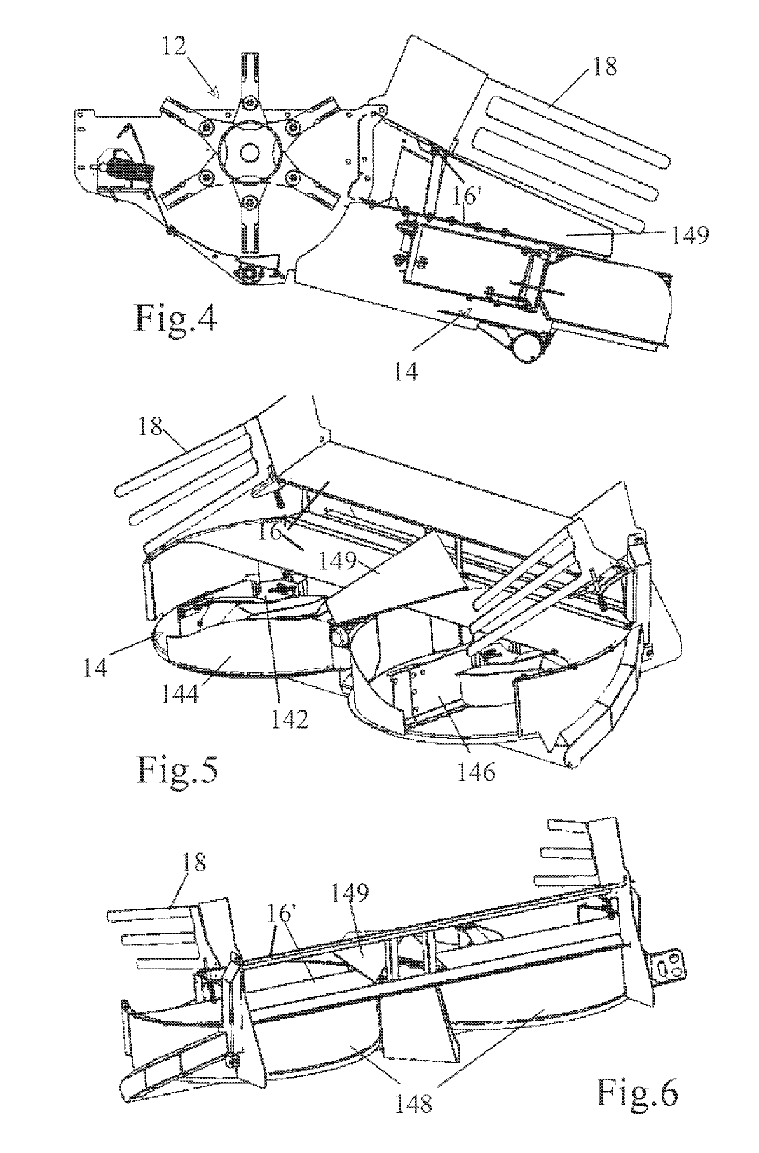

A combine harvester of the present invention is capable of discharging stalks in both of the ways described above. However, in addition, the stalks can be guided in a third way, as will now be described with reference to FIGS. 3 to 6, so that the stalks are evenly spread un-chopped over the full width of the strip traversed by the header of the combine harvester.

In FIGS. 3 to 6, the stalks are once again prevented from entering the chopper 12 and are guided to drop onto a chute that lies above the spreader 14, In this case, however, comparison of FIGS. 1 and 3 will show that in place of a chute 16 that totally overlies the spreader 14, a shorter chute 16′ is used that terminates near the axis of the rotors 142 so that the stalks drop into the spreader 14.

Two further modifications are also made to the discharge system to enable the unchopped stalks to be spread evenly over a wide area. First, as the chopper is not now in use, it is necessary to prevent the talks from being driven back into the chopper as this could cause a blockage, This is achieved by fitting a cover 148 as shown in FIG. 6 to the spreader, the cover 148 being shaped to act as an extension of the cylindrical shielding 144 surrounding the rotors 142 of the spreader 14. Second, it is necessary to ensure that the stalks enter one or other of the two halves of the spreader and do not fall to the ground between the two halves. This is achieved by means of a nose 149 centrally mounted above the surface of the chute 16′. The nose 149 is of triangular cross section with inclined sides and its height reduces gradually towards the rear of the combine harvester.

The flow control guides that are operator configurable consist of the deflector mounted above the mouth of the chopper, the chutes 16 and 16′, the spreader rear cover 148 and the nose 149. The chute 16 can be formed with a slidable, pivotable or removable flap to act as the chute 16′. The rear cover 148 of the spreader 14 may be formed as a retractable door and the nose 149 may be left in place all the time as its presence would not interfere with the operation of laying the stalks as swaths. Consequently, it is possible to design the flow control guides such as to enable the operator to switch between different operating modes of the stalk discharge system without the need to attach or dismount additional components.

In order to achieve even spreading of the stalks to take into account the prevailing operating conditions, it is possible to provide adjustment of the spreader shielding 144 both to rotate it relative to the axis of the rotor 142 so as to alter the angle at which the stalks leave the spreader 14 and to vary the distance between the shielding 144 and the tips of the blades 146. Such an adjustment may be carried out independently on the two halves of the spreader 14.

It is clear that this system is equally suitable for spreading maize cobs and associated leaves evenly over the field without chopping them and without requiring an additional spreader device.

It will be readily appreciated that various modifications may be made to the described embodiment without departing from the scope of the invention as set out in the appended claims. For example, the spreader may employ rotating rakes in place of blades.

1. A combine harvester comprising:
a header for gathering crop from a field; and
threshing and separation mechanisms for separating the crop into grain, stalks and chaff; and
a stalk discharge system (10), whereby the stalk discharge system (10) includes a chopper (12), a spreader (14) and flow control guides for defining multiple operator configurable flow paths through the stalk discharge system (10), wherein the flow paths include a first flow path in which the stalks pass sequentially through the chopper (12) and the spreader (14) to be chopped and evenly distributed over the ground just traversed by the header, and a second flow path in which the stalks bypass the chopper (12) and the spreader (14) to be deposited as a swath on the ground, wherein the flow control guides are additionally configurable to define a third flow path in which the stalks enter the spreader (14) without first passing through the chopper (12), to be evenly distributed un-chopped over the ground just traversed by the header.

2. A combine harvester as claimed in claim 1, wherein the spreader includes two rotors (142) that are counter-rotatable and a shielding (144) partially surrounding the rotors (142), there being a rear opening in the shielding (144) for admitting into the spreader (14) stalks chopped by the chopper (12) when the stalks follow the first flow path, and such that in the third flow path,. the flow control guides comprise a rear cover (148) for the rear opening in the shielding of the spreader to prevent back flow of the stalks from the spreader (14) into the chopper (12).

3. A combine harvester as claimed in claim 1, such that in the second flow path, the stalks pass over a chute (16) prior to their deposition on the ground as a swath, and wherein a panel is provided in the chute (16) which is movable or removable to enable the stalks to flow into the spreader (14) when the flow control guides are configured to define the third flow path.

4. A combine harvester as claimed in claim 3, wherein the shielding (144) is spaced from the rotors (142) to allow a part of the flow to drop to the ground while the remainder is flung the rotors (142) and deflected by the shielding (144) to achieve the desired even distribution and ground coverage.

5. A combine harvester as claimed in claim 4, wherein the distance between the shielding (144) and the rotors (142) is adjustable.

6. A combine harvester as claimed in claim 3, such that in the third flow path, the flow control guides include a flow divider (149) that cooperates with the chute (16) to direct the flow of stalks into the volume of the spreader swept by the rotors and to deflect the flow away from the centreline of the spreader (14).
